(19) United States
(12) Patent Application Publication
(10) Pub. No.: US 2005/0251849 A1
(43) Pub. Date: Nov. 10, 2005

(54) Teletex receiver arrangement

(75) Inventor: Taras Telyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,201

(22) PCT Filed: Aug. 4, 2003
(86) PCT No.: PCT/IB03/03438

§ 371 Date: Mar. 1, 2005

(30) Foreign Application Priority Data
Sep. 2, 2002 (EP) 02078589.5

(51) Int. Cl. H04N 11/00

(52) U.S. Cl. 725/137; 348/468

(57) ABSTRACT

A teletext receiver arrangement comprises a receiver for receiving broadcast data including teletext data elements through a broadcast channel (8,9); a teletext processor (12,13) for extracting the teletext data elements from the broadcast data; and processor (13) for generating a video signal encoding a customized teletext page from the teletext data elements according to a set of instructions. The teletext receiver arrangement comprises all interface (20) for establishing a connection to a server (7) through an interaction channel (21), and is programmed to download a piece of computer code implementing the set of instructions from the server (7) through the interaction channel (21).

The invention relates to a teletext receiver arrangement, comprising
a receiver for receiving broadcast data including teletext data elements through a broadcast channel;
a teletext processor for extracting the teletext data elements from the broadcast data; and
a processor for generating a video signal encoding a customized teletext page from the teletext data elements according to a set of instructions.

The invention further relates to a method of adapting a teletext receiver arrangement that comprises a receiver for receiving broadcast data, including teletext data elements, through a broadcast channel;
a teletext processor for extracting the teletext data elements from the broadcast data;
a processor for generating a video signal encoding a customized teletext page from the teletext data elements according to a set of instructions.

The invention also relates to a server set up to execute such a method.

The invention also relates to a computer program product, having the capability, when run on a server, to make the server execute such a method.

The invention further relates to a television receiver, comprising a teletext receiver arrangement according to the opening paragraph.

The invention lastly relates to a computer program product for a television broadcast receiver terminal.

A teletext receiver arrangement as defined in the opening paragraph is disclosed in International Patent Application WO 01/91456. The prior art arrangement allows a user to select teletext information for reproduction in an information bar which is displayed simultaneously with a television program.

In this system, only customization of a pre-determined type is possible. The user merely defines which information is to be shown in the information bar. To provide a different type of customization, a different set of algorithms would have to be programmed into the chip. This cannot be done locally by a user, since such a programming environment would require a more powerful chip than is generally available in a television set.

It is an object of the invention to provide a teletext receiver arrangement, method of adapting such an arrangement, server and television receiver of the type mentioned above that allow a versatile customization of teletext pages.

This object is achieved by the teletext receiver arrangement according to the invention, comprising
a receiver for receiving broadcast data including teletext data elements through a broadcast channel;
a teletext processor for extracting the teletext data elements from the broadcast data; and
a processor for generating a video signal encoding a customized teletext page from the teletext data elements according to a set of instructions; wherein the teletext receiver arrangement comprises an interface for establishing a connection to a server through an interaction channel, and is programmed to download a piece of computer code implementing the set of instructions from the server through the interaction channel.

New and different types of instructions can thus be compiled into a code that is executable or interpretable by the processor for generating a video signal. Compilation can be done externally, i.e. not on the device incorporating the teletext receiver arrangement, e.g. a television or set top box. The code is placed on the server and downloaded to the television or set top box. Thus, the device does not need the computer resources to host a complete development environment. On the other hand, new types of instructions can be provided. This makes the customization more versatile, since new types of instructions can be provided throughout the lifetime of the television or set-top box.

According to an aspect of the invention, a method of adapting a teletext receiver arrangement that comprises a receiver for receiving broadcast data, including teletext data elements, through a broadcast channel;
a teletext processor for extracting the teletext data elements from the broadcast data; and
a processor for generating a video signal encoding a customized teletext page from the teletext data elements according to a set of instructions; is provided, the method comprising transferring a piece of computer code implementing the set of instructions from a server, connected to the teletext receiver arrangement by means of an interaction channel, to the teletext receiver arrangement through the interaction channel.

This is the method that is carried out by the system of the server and teletext receiver arrangement, in order to adapt the latter to provide customized teletext pages. By the use of this method, a wider range of types of customization can be deployed in the teletext receiver arrangement.

Preferable, the method comprises assembling a set of instructions in response to commands received from a terminal connected to the server through a network, and generating the piece of code from the assembled set of instructions.

Thus, using the terminal, which can be a personal computer, interactive television or set-top box, it is possible to program the teletext receiver arrangement, without a programming environment being available on the device incorporating the teletext receiver arrangement.

According to a further aspect of the invention, a server is provided, set up to execute a method according to any one of claims 7-16.

The server thus set up provides the means for adapting one or more teletext receiver arrangements to providing different types of customized teletext pages.

According to another aspect of the invention, a computer program product is provided, having the capability, when run on a server, to make the server execute a method according to any one of claims 7-16.

With this computer program product, a general server can be used to provide the adaptation function of the invention.

According to yet another aspect of the invention, a television receiver is provided, comprising a teletext receiver arrangement according to any one of claims 1-6.

The television receiver, which can be a set-top box or a conventional television set, for example, is thus more versatile. It can provide many different types of customized teletext pages, namely as many as are made available on the server, to which it is connected, when in use.

The invention will now be explained in further detail with reference to the accompanying drawings.

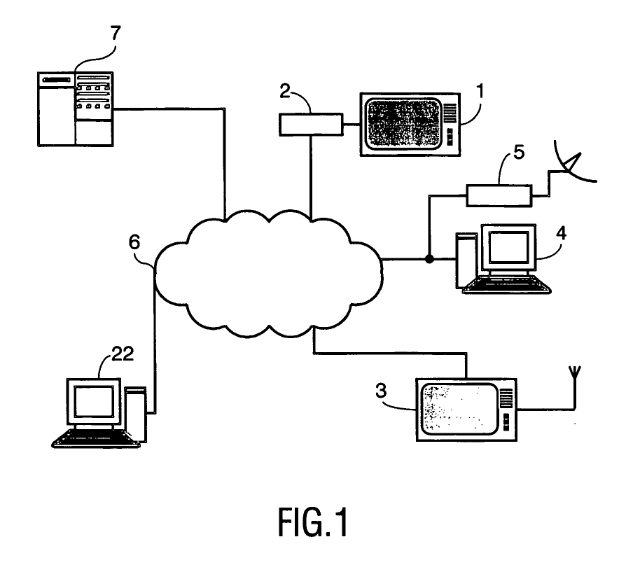

FIG. 1 is a schematic diagram of a broadcast system in which the invention can be implemented.

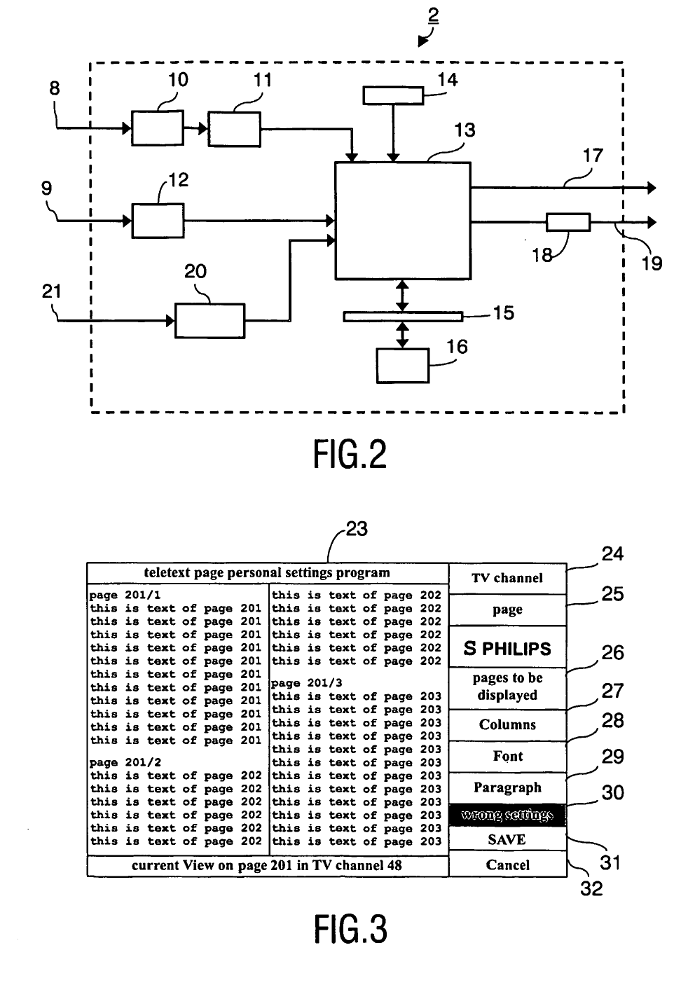

FIG. 2 is a schematic diagram of the components of a hybrid set top box incorporating a teletext receiver arrangement according to the invention.

FIG. 3 is a screen view of the user interface provided by the server for programming a customized teletext page.

The invention is intended for interactive broadcast receivers, of which FIG. 1 shows a view examples. In FIG. 1, a conventional television set 1, is connected to a set-top box 2 receiving a television broadcast signal through, for example, a cable connection. An interactive television set 3 receives a broadcast signal from a terrestrial broadcast connection. A personal computer 4 with broadcast or multicast receiver hardware and software receives a broadcast signal using a satellite tuner 5. All of the mentioned receivers are also connected to a network 6, e.g. the Internet: they comprise a back channel, for upstream transmission of data, for example to a server 7, connected to the network 6.

FIG. 2 shows schematically some of the major components of the set-top box 2, as an example of such a broadcast receiver. The set-top box 2 is a hybrid broadcast receiver, having a input 8 for digital and an input 9 for analogue broadcast data, to emphasize the fact that the invention is not limited to either one of these types of broadcast data. To this end, the set-top box 2 comprises a tuner 10 and a digital decoder 11. The latter will differ according to whether the input 8 is intended for satellite, cable or terrestrial reception. The broadcast data provided on the input 9 for analogue data is processed by a video decoder 12. The video decoder 12 converts the broadcast data from the input format, e.g. PAL, NTSC, or SECAM CVBS, into color component values. In addition, the video decoder captures serially encoded data comprised in the virtual blanking interval (VBI) of the broadcast signal. Principally, this data comprises teletext data elements.

In the example of FIG. 2, both the digital decoder 11 and the video decoder 12 are connected to a Home Entertainment Engine 13 (HEE). In this case, the HEE 13 is a so-called System on a Chip, meaning that a number of integrated circuits are integrated into one chip, each performing a specific function in the processing of video and audio data. The HEE 13 has a memory controller and interface to Random Access Memory 14, and a bus controller and interface to PCI/XIO bus 15. An extra memory module 16 can be addressed through the bus 15. The memory module can be Nor, NAND or Sync flash memory, or an (E)EPROM device. The HEE 13 processes digital broadcast data received from the digital decoder 11, carrying out amongst others, the processing of a transport stream, demultiplexing and descrambling. It comprises a 2D graphics engine and an on-screen graphics unit. The latter defines a user interface and subtitling elements and superimposes them on picture outputs using titling, teletext insertion and VBI insertion as needed. A digital video encoder in the HME 6 encodes primary digital (YCbCr) video data, which can be a mix of graphic and video, to create an NTSC, PAL, SECAM CVBS or S-video signal. It also creates an RGB signal for output to a display, via video output 17. A digital audio signal is converted to analogue format by a converter 18, and made available through audio output 19

It will be understood, that there are different ways in which teletext can be implemented and decoded. The term teletext receiver arrangement, as used in the context of this application, will be understood to mean the collection of hardware and software components that together extract teletext data elements from the broadcast signal, and process these. According to the invention, the teletext receiver arrangement is capable of generating a video signal encoding a customized teletext page from the teletext data elements according to a set of instructions. The generated video signal can be any of the above mentioned signals created by the HEE 13. Thus, the customized teletext page can be made available in an RGB signal for direct use by a display, or it can itself be inserted into the VBI in a television signal to be provided to television set 1 (FIG. 1) or to a VCR (not shown).

The HEE 13 is also connected to a modem 20, which can be a cable modem, DSL modem, or conventional modem, providing access to the network 6 (see FIG. 1) through an interaction channel 21. Through this channel 21 data can be both uploaded and downloaded to the set-top box 2. According to the invention, a piece of code implementing a set of instructions for generating a video signal encoding a customized teletext page is downloaded. This code can then be executed or interpreted by a processor in the HEE 13.

Although the invention is not limited to any particular type of set top box 2, it is noted that set-top boxes conforming to the Multimedia Home Platform standard (MHP) provide a particularly favorable environment for implementing the invention. This platform is organized into three layers. The first layer is formed by the system resources, the second by the system software and the third by applications. The system software comprises a Java Virtual Machine, providing a common interface to programs, so called Xlets, which can be run on the system.

In such an embodiment of the invention, an Xlet is provided to the set-top box 2, implementing a set of instructions for creating customized teletext pages using the teletext data elements extracted from the received broadcast signal. Referring to FIG. 1, set-top box 2 is programmed to download the Xlet from the server 7, to which it is connected through the network 6. This has the advantage that different types of customization can be carried out, depending on the types of Xlets available from the server 7. The advantage of downloading the Xlets over generating them in the set-top box 2, is that this would quickly place too large demands on the processing capacity of the HME 6. To generate an Xlet in a user-friendly development environment requires more system resources than to run one.

In a first embodiment of the invention, the code is downloaded during operation of the set-top box 2, after it has been switched on. This has the advantage that the code can be saved to RAM 14. It does not need to be stored. An embodiment is possible wherein the code is provided in a continuous stream of data from the server 7. This is useful when the set-top box 2 can access the network 6 through a connection that is always on.

In another embodiment, the code is downloaded and saved to memory module 16. This has the advantage that the set-top box 2 is not dependent on the server 7, so that it will continue to function if the server 7 is temporarily unavailable.

In order to allow the server 7 to transmit different pieces of code to various receivers connected to it, the teletext receiver arrangement is programmed to transmit a unique identification code to the server, identifying the piece of code to be downloaded. This is primarily useful for all embodiments of the invention in which the code is not streamed to the receivers, but downloaded at certain times. It is noted that the use of a unique identification code can be advantageously used to uniquely identify the type of device in which the teletext pages are displayed. Thus different types of customization can be deployed in television sets with a wide screen from those used in smaller sets, for example. In an even more advantageous embodiment, the identification code can be used to distinguish between users of individual appliances, thus allowing each user to apply his own type of customization.

Every user can have their own set piece of code, implementing their preferences. The invention provides a mechanism for generating this code, as well. Using either the set-top box 2 in combination with the television set 1, or a separate personal computer 22, the user can access a special web site hosted on the server 7, or on another server connected to the server 7. The web site serves as a front end, providing an interface to a program for generating the piece of code that implements the set of instructions for generating one or more customized teletext pages. The set-top box 2 or personal computer 22 serves as a terminal for entering commands to this program.

If the user accesses the web site using the set-top box 2, which is to generate the customized teletext pages, the set-top box 2 can be programmed to provide the server 7 with the unique identification code for this set-top box 2. It can do this automatically or upon interrogation by the server 7, using a specific protocol, for example. Alternatively, the server 7 can prompt the user for an identification code that is unique to the teletext receiver arrangement in the set-top box 2. This is advantageous, because the user can thus access the server 7 from any terminal, like the computer 22. The piece of code generated by the server 7 is linked to the unique identification code, so that it can be downloaded to the correct set-top box 2 afterwards.

An embodiment is also envisaged in which a password is provided by the user of the set-top box 2 with the unique identification code. This can be used to prevent unauthorized persons from changing the settings of the set-top box 2 by downloading a different piece of code.

FIG. 3 shows an example of a graphical user interface (GUI) provided as part of the invention. It comprises a screen view 23 of the customized teletext page, showing what the customized teletext page will look like, if generated by the set-top box 2 according to the current settings.

Commands are entered by clicking on a series of buttons 24-29,31 comprised in the GUI.

As is well known, e.g. from European Telecommunication Standard 300 706, teletext data is organized into packets. Packets comprise the data for a teletext page. One or more pages together form a magazine. One or more magazines may be comprised in a teletext service. There is one teletext service per broadcast channel.

Preferably, the user is able to provide instructions for generating a plurality of different customized pages. A channel selection button 24 allows the user to select a channel, and thus a teletext service. A page selection button 25 allows the user to select a page from that service. After selecting a page from a service, the user can then proceed to customize the appearance of that page. Later, when the code implementing the instructions for generating the customized page has been downloaded to the set-top box 2, the set-top box 2 will generate the customized page instead of the standard page in response to a selection command for that page.

In one embodiment, the server 7 provides a choice between a number of pre-defined templates. This has the advantage of being a very user-friendly way of specifying the type of customized teletext page to be generated. Little time is needed to familiarize oneself with the commands, and little time is spent on-line.

In an alternative embodiment, in conjunction with which the GUI of FIG. 3 is provided, the user has more scope for customization. In this embodiment, for example, code for the set-top box 2 can be generated that, when run on the set-top box 2, enables the teletext receiver arrangement to assemble teletext data elements from two or more pages into the customized teletext page. Preferably, the code enables the teletext receiver arrangement to assemble teletext data elements from two or more pages that are part of different teletext services into the customized teletext page.

By clicking on a button 26 the user can specify which data elements from which pages are to be added to the customized teletext page. In the example of FIG. 3 text from pages 201, 202 and 203 is combined into a new customized page 201. Thus, using the invention, the user can assemble information, relating to a topic of his interest, from different sources into one single customized teletext page. Preferably, as soon as the user has defined data elements to be added to the customized teletext page, software on the server 7 automatically computes those settings for the customized teletext page (column, font and paragraph settings) that will allow all the selected information to fit on the screen of the television set 1.

In the context of the invention, a customized teletext page is any teletext page that differs in appearance from the teletext pages provided by a broadcaster. Thus, it need not necessarily differ (only) in terms of the contents, but can also differ in terms of its appearance. For example, by clicking on a ‘columns’ button 27, the user can change the arrangement into columns of the teletext page contents. This is useful if the user knows that he will be viewing the pages on a wide format screen, so that multiple columns can be arranged side by side without impairing the legibility. By clicking on a ‘font’ button 28, the user can change the appearance of the text, e.g. the size and/or color in which it is displayed. By clicking on a ‘paragraph’ button 29, the user can change the arrangement of the teletext information into paragraphs, for example according information from each originally broadcast page a separate paragraph in the customized page. Lines can additionally separate the columns or paragraphs, so that the user will know from which pages the elements of the customized page originated. With this button 29, the user can additionally alter the line spacing and paragraph spacing, to fit the information onto the page in the best way possible.

According to the invention, the set of instructions according to which the customized teletext page is to be generated, is checked against one or more criteria. Thus, the user cannot specify a customized teletext page that cannot be generated by the teletext receiver arrangement. This feature can also be used to prevent the generation of customized pages that cannot be displayed legibly on the target television set. In the GUI of FIG. 3, a ‘wrong settings’ field 30 will start to blink as soon as the criteria are not fulfilled.

In a preferred embodiment of the invention, the piece of code that is to be downloaded to the teletext receiver arrangement is not generated if the criteria have not been met. If the criteria have been met, and the user is satisfied with the appearance of the customized teletext page, a click on the ‘save’ button 31 will ensure that the code to be downloaded is generated. In case the user decides not to change the customized teletext page (keep old settings), a click on a ‘cancel’ button 32 will result in no new downloaded code being generated.

It will be understood that the invention is not limited to the embodiments described above, which can be varied in a number of ways within the scope of the claims. For instance, alternative interfaces to the program for generating the piece of code to be downloaded are possible. In addition, the interface need not be provided by means of a web front end that can be accessed through the Internet. An alternative way of accessing the program on the server 16 is also possible.

1. Teletext receiver arrangement, comprising
a receiver for receiving broadcast data including teletext data elements through a broadcast channel;
a teletext processor for extracting the teletext data elements from the broadcast data; and
a processor for generating a video signal encoding a customized teletext page from the teletext data elements according to a set of instructions; wherein the teletext receiver arrangement comprises an interface for establishing a connection to a server through an interaction channel, and is programmed to download a piece of computer code implementing the set of instructions from the server through the interaction channel.

2. Teletext receiver arrangement according to claim 1, further comprising a memory device, wherein the arrangement is programmed to store the downloaded piece of computer code in the memory device, and wherein, in use, the code is retrieved from the memory device.

3. Teletext receiver arrangement according to claim 1, wherein the teletext receiver arrangement is programmed to transmit a unique identification code to the server, identifying the piece of code to be downloaded.

4. Teletext receiver arrangement according to claim 1, wherein the teletext receiver arrangement is capable of executing code enabling it to assemble teletext data elements from two or more pages into the customized teletext page.

5. Teletext receiver arrangement according to claim 4, wherein the teletext receiver arrangement is capable of executing code enabling it to assemble teletext data elements from two or more pages that are part of different teletext services into the customized teletext page.

6. Teletext receiver arrangement according to claim 1, comprising means for providing a page selection command, wherein the teletext receiver arrangement is capable of generating one of a plurality of customized pages by running the program code, in response to a page selection command.

7. Method of adapting a teletext receiver arrangement that comprises a receiver for receiving broadcast data, including teletext data elements, through a broadcast channel;
a teletext processor for extracting the teletext data elements from the broadcast data; and
a processor for generating a video signal encoding a customized teletext page from the teletext data elements according to a set of instructions, the method comprising transferring a piece of computer code implementing the set of instructions from a server, connected to the teletext receiver arrangement by means of an interaction channel, to the teletext receiver arrangement through the interaction channel.

8. Method according to claim 7, comprising assembling a set of instructions in response to commands received from a terminal connected to the server through a network, and generating the piece of code from the assembled set of instructions.

9. Method according to claim 8 comprising making a graphical user interface available on the terminal, comprising a screen view of the customized teletext page.

10. Method according to claim 8, comprising prompting the user of the terminal for an identification code unique to a teletext receiver arrangement, linking the generated piece of code to the identification code received in response to the prompt, and transferring the code to the teletext receiver arrangement identified by the code.

11. Method according to claim 7, comprising the generation of a piece of code that, when run on the teletext receiver arrangement, enables the teletext receiver arrangement to assemble teletext data elements from two or more pages into the customized teletext page.

12. Method according to claim 11, comprising the generation of a piece of code that that, when run on the teletext receiver arrangement, enables the teletext receiver arrangement to assemble teletext data elements from two or more pages that are part of different teletext services into the customized teletext page.

13. Method according to claim 8, wherein the set of instructions are checked against one or more criteria.

14. Method according to claim 13, wherein the piece of code is only generated if the criteria have been met.

15. Method according to claim 9, comprising making a user interface available on the terminal through which a user can select one of a plurality of templates for a customized teletext page, and generating the piece of code in response to a selection command received from the terminal.

16. Method according to claim 9, wherein a piece of code is generated that, when run on the teletext receiver arrangement enables it to generate one of a plurality of customized pages, in response to a page selection command.

17. Server set up to execute a method according to claim 7.

18. Computer program product, having the capability, when run on a server, to make the server execute a method according to claim 7.

19. Television receiver, comprising a teletext receiver arrangement according to claim 1.

20. Computer program product for a television receiver comprising a receiver for receiving broadcast data including teletext data elements through a broadcast channel;
a teletext processor for extracting the teletext data elements from the broadcast data;
a processor for generating a video signal encoding a customized teletext page from the teletext data elements according to a set of instructions; and
an interface for establishing a connection to a server through an interaction channel, wherein the computer program product, when run on the television receiver, enables it to function as a television receiver according to claim 19.
